(19) United States
(12) Patent Application Publication
(10) Pub. No.: US 2019/0285968 A1
(43) Pub. Date: Sep. 19, 2019

(54) OCCUPANT MONITORING APPARATUS

(71) Applicant: OMRON Corporation, Kyoto-shi, (JP)

(72) Inventor: Koichi HOSHINO, Komaki-shi (JP)

(73) Assignee: OMRON Corporation, Kyoto-shi (JP)

(21) Appl. No.: 16/289,697

(22) Filed: Mar. 1, 2019

(30) Foreign Application Priority Data
Mar. 15, 2018 (JP) 2018-47430

(51) Int. Cl. G03B 11/04; G03B 17/12; G06K 9/20; H04N 5/225

(52) U.S. Cl. CPC G03B 11/045; G03B 17/12; G06K 9/00845; H04N 5/2254; H04N 5/2252; G06K 9/209

(57) ABSTRACT

To prevent noise caused by ambient light entering from outside an angle of view of a lens from appearing in a captured image, an occupant monitoring apparatus for monitoring a driver based on a captured image includes an imaging device that captures an image of a vehicle driver, a lens that forms the image of the driver onto an imaging surface of the imaging device, a holder holding the lens, a cover covering the imaging device, the lens, and the holder, and a transmissive plate on the cover and in a window allowing light to enter the lens. A light shield is opposite to the imaging device from the lens to block light entering from outside an angle of view of the lens and prevent the light from entering the lens.

### CROSS-REFERENCE TO RELATED APPLICATION

This application claims priority to Japanese Patent Application No. 2018-047430 filed on Mar. 15, 2018, the entire disclosure of which is incorporated herein by reference.

### FIELD

The present invention relates to an occupant monitoring apparatus for monitoring an occupant of a vehicle based on an image captured by an imaging device.

### BACKGROUND

An occupant monitoring apparatus may be installed in the interior of a vehicle for monitoring the physical state of an occupant of the vehicle based on a captured image to prevent, for example, vehicle accidents.

For example, an occupant monitoring apparatus described in Patent Literature 1 captures an image of a driver's face with an imaging device (image sensor), such as a charge coupled device (CCD) or a complementary metal oxide semiconductor (CMOS), and determines the face orientation based on the captured image. Another occupant monitoring apparatus may monitor, for example, the degree of opening of the driver's eyes, in addition to the driver's face orientation, based on the captured image. The monitoring result of the occupant monitoring apparatus is output to an electronic control unit (ECU) in the vehicle, and is used to control driving of the vehicle.

Light reflected from the occupant is focused through a lens onto the imaging surface of the imaging device. To position the lens appropriately with respect to the imaging surface of the imaging device, the lens is held on a holder (including a lens frame) as described in, for example, Patent Literature 2 and Patent Literature 3. The imaging device, the lens, and the holder are enclosed in an enclosure (a lens barrel, a diaphragm plate, or a package) for protection and other purposes. The holder or the enclosure is formed from a light-shielding material. The holder or the enclosure has a window to allow light to enter the lens. In Patent Literature 2 or Patent Literature 3, the window is a hole.

To prevent entry of foreign matter, the window may include a hole and a transmissive plate that closes the hole as described in Patent Literature 4. The transmissive plate is formed from a light transmissive material. In Patent Literature 4, the transmissive plate has the plate surface perpendicular to or tilting to a second optical axis of light entering the lens.

The window in the occupant monitoring apparatus allowing entry of light from the occupant also allows entry of ambient light, such as sunlight. The ambient light passing through the lens may enter the imaging device. Also, the ambient light is partially reflected by the lens or other components to be stray light, which then passes through the lens and enters the imaging surface of the imaging device. In such cases, the ambient light and the stray light may appear as noise in the captured image. This may disable detection of an occupant's face or face feature points, and degrade the occupant monitoring performance.

In response to this, Patent Literature 2 describes a stray light reflecting surface at the inner circumference of the lens frame. The stray light reflecting surface reflects light entering through an aperture and not contributing to the image formation on the imaging surface of the lens, and releases such stray light outside through the aperture. Patent Literature 3 describes a light-shield between the lens and the holder to prevent stray light entering the lens through the aperture from being reflected inside the holder and reaching the imaging device.

### CITATION LIST

### Patent Literature

Patent Literature 1: Japanese Unexamined Patent Application Publication No. 2004-78778

Patent Literature 2: Japanese Unexamined Patent Application Publication No. 2007-163637

Patent Literature 3: Japanese Unexamined Patent Application Publication No. 2003-307663

Patent Literature 4: Japanese Unexamined Patent Application Publication No. 12015-179507

### SUMMARY

### Technical Problem

Ambient light such as sunlight may enter the lens not only within the angle of view of the lens but also from outside the angle of view of the lens after passing through the window. The ambient light entering from outside the angle of view of the lens may be reflected on the lens surface or by another component to be stray light, which may then pass through the lens within the angle of view of the lens and enter the imaging surface of the imaging device. Such stray light may appear as noise in an image of an occupant, and may disable detection of a face or other feature and degrade the occupant monitoring performance.

One or more aspects of the present invention are directed to an occupant monitoring apparatus that prevents ambient light entering a lens from outside the angle of view of the lens from appearing as noise in a captured image.

### Solution to Problem

An occupant monitoring apparatus according to one aspect of the present invention monitors an occupant based on an image captured by an imaging device.

The apparatus includes an imaging device that captures the image of an occupant of a vehicle, a lens that forms an image of the occupant onto an imaging surface of the imaging device, a holder holding the lens, a cover covering the imaging device, the lens, and the holder, a window located in the cover to allow light to enter the lens, and a light shield located opposite to the imaging device from the lens. The light shield blocks light entering from outside an angle of view of the lens and prevents the light from entering the lens.

In the above structure, the light shield blocks ambient light, such as sunlight, entering from outside the angle of view of the lens from entering the lens, and thus prevents the ambient light from passing through the lens and entering the imaging surface of the imaging device. The above structure also prevents the ambient light from being reflected by the lens surface to be stray light, and thus eliminates stray light passing through the lens and entering the imaging surface of the imaging device. This prevents noise caused by ambient light entering from outside the angle of view and stray light from appearing in the captured image.

In the apparatus according to the above aspect, the window may include a hole in the cover, and a transmissive plate attached to the cover to close the hole. The transmissive plate transmits light. The transmissive plate may have plate surfaces tilting with respect to an optical axis of the lens.

In the apparatus according to the above aspect, the transmissive plate may have a larger diameter than the lens.

In the apparatus according to the above aspect, the light shield may be a plate, and may be located on a plate surface of the transmissive plate facing the imaging device. A plate surface of the light shield and the plate surfaces of the transmissive plate may be parallel to each other.

In the apparatus according to the above aspect, the light shield may be annular to surround a range of the angle of view of the lens.

In the apparatus according to the above aspect, the light shield may extend radially outward from positions adjacent to the range of the angle of view of the lens.

The light shield may have a larger outer diameter than the lens.

In the apparatus according to the above aspect, the light shield may have a surface receiving anti-light reflection treatment.

### Advantageous Effects

The occupant monitoring apparatus according to the above aspects of the present invention prevents ambient light entering a lens from outside the angle of view of the lens from appearing as noise in a captured image.

### BRIEF DESCRIPTION OF THE DRAWINGS

FIG. 1 is an electric block diagram of an occupant monitoring apparatus according to an embodiment of the present invention.

FIG. 2 is a perspective view of an occupant monitoring apparatus according to a first embodiment of the present invention.

FIG. 3 is a perspective view of the occupant monitoring apparatus shown in FIG. 2 with its cover removed.

FIG. 4 is a perspective view of the occupant monitoring apparatus shown in FIG. 3 with its lid and harness removed.

FIG. 5 is a perspective view of the cover shown in FIG. 2.

FIG. 6 is a cross-sectional view of an imaging system included in the occupant monitoring apparatus shown in FIG. 2.

FIG. 7 is a diagram describing an example image captured by the imaging system shown in FIG. 6.

FIG. 8 is a diagram describing the posture of the imaging system shown in FIG. 6 as installed.

FIG. 9 is a cross-sectional view of an imaging system included in a known occupant monitoring apparatus.

FIG. 10 is a diagram describing an example image captured by the imaging system shown in FIG. 9.

FIG. 11 is a cross-sectional view of an imaging system included in an occupant monitoring apparatus according to a second embodiment of the present invention.

FIG. 12 is a cross-sectional view of an imaging system included in an occupant monitoring apparatus according to a third embodiment of the present invention.

FIG. 13 is a cross-sectional view of an imaging system included in an occupant monitoring apparatus according to a fourth embodiment of the present invention.

FIG. 14 is a cross-sectional view of an imaging system included in an occupant monitoring apparatus according to a fifth embodiment of the present invention.

FIG. 15 is a cross-sectional view of an imaging system included in another known occupant monitoring apparatus.

### DETAILED DESCRIPTION

Embodiments of the present invention will now be described with reference to the drawings. In the figures, the same or corresponding components are given the same reference numerals.

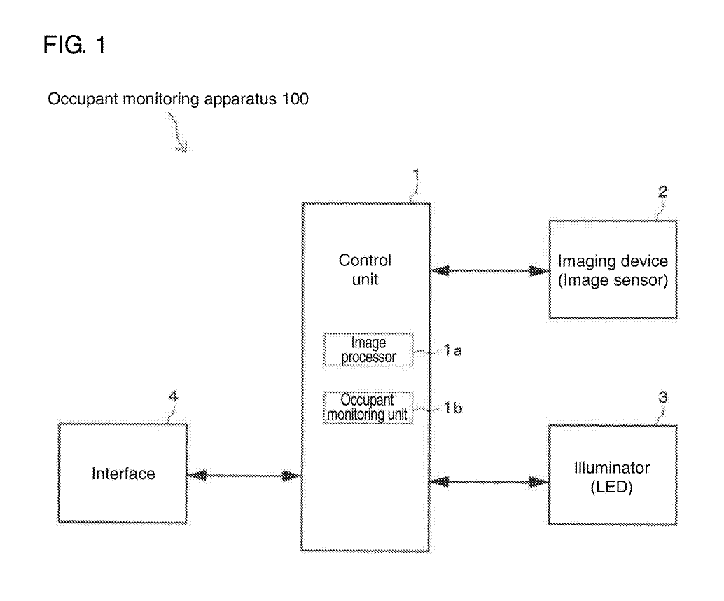

FIG. 1 is an electric block diagram of an occupant monitoring apparatus 100 according to an embodiment of the present invention. The occupant monitoring apparatus 100 is installed in the interior of a vehicle, such as an automobile. The occupant monitoring apparatus 100 includes a control unit 1, an imaging device 2, an illuminator 3, and an interface 4.

The control unit 1 includes a microcomputer and a memory. The control unit 1 includes an image processor la and an occupant monitoring unit 1 b. The imaging device 2 includes an infrared image sensor. The illuminator 3 includes a plurality of infrared light emitting diodes (LEDs). FIG. 1 shows the illuminator 3 as a single block. The interface 4 includes a circuit for in-vehicle communication, such as a controller area network (CAN).

The imaging device 2 captures an image of a face of a driver, who is an occupant of a vehicle. The illuminator 3 emits infrared light toward an area including the face of the driver. The control unit 1 controls the image capturing operation of the imaging device 2 and the light emitting operation of the illuminator 3.

The image processor 1a in the control unit 1 processes an image captured by the imaging device 2, and detects feature points in the face of the driver in time series. The occupant monitoring unit 1b detects the driver's conditions including the face orientation, eye opening or closing, and gaze based on changes in the feature points in the face. The occupant monitoring unit 1b monitors these changes and determines whether the driver has any abnormality that possibly affects driving. The control unit 1 outputs the monitoring result obtained by the occupant monitoring unit 1b to another electronic control unit (ECU) in the vehicle through the interface 4. The control unit 1 also receives information about the vehicle speed, the driver's presence, and other information from another ECU and various sensors in the vehicle.

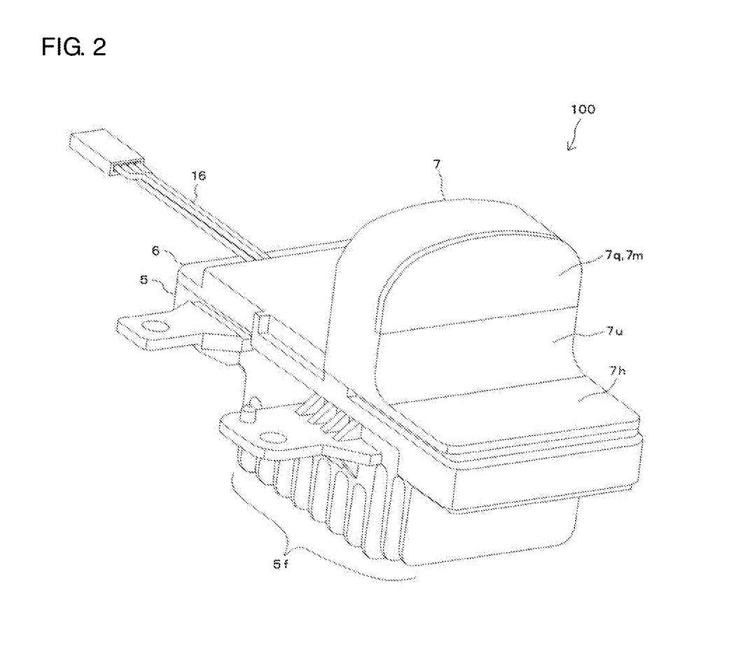

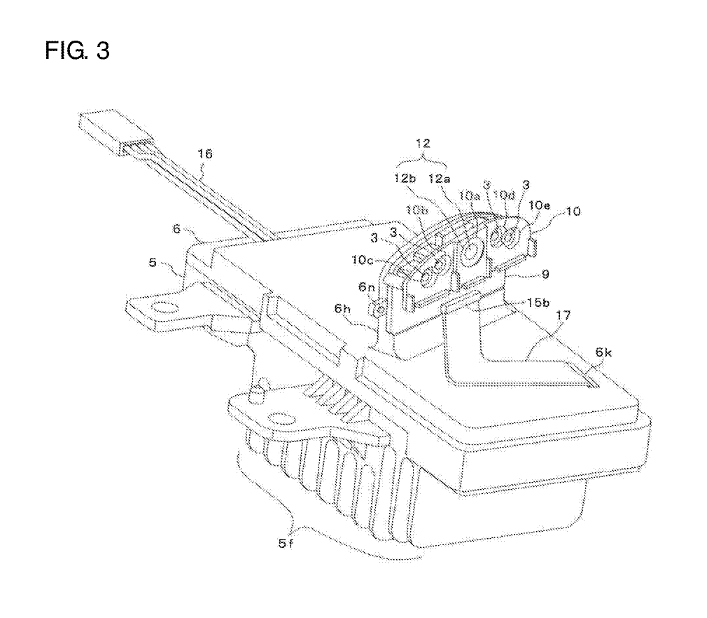

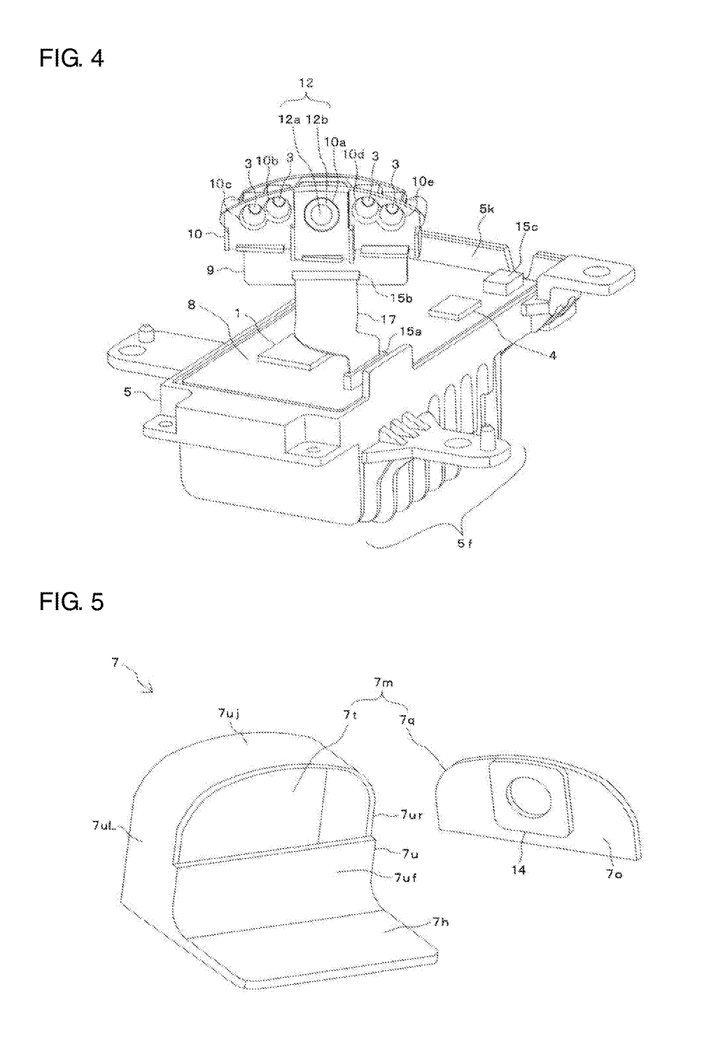

FIG. 2 is a perspective view of the occupant monitoring apparatus 100 according to a first embodiment of the present invention. FIG. 3 is a perspective view of the occupant monitoring apparatus 100 shown in FIG. 2 with a cover 7 removed. FIG. 4 is a perspective view of the occupant monitoring apparatus 100 shown in FIG. 3 with a lid 6 and a harness 16 removed. FIG. 5 is a perspective view of the cover 7.

As shown in FIG. 2, the occupant monitoring apparatus 100 is installed in the vehicle interior with a housing 5 on the bottom, the cover 7 on the top, and an end face of the cover 7 opposite to a window 7m facing the front of the vehicle. The occupant monitoring apparatus 100 is mounted in the middle of the dash board, which is diagonally in front of the driver, or mounted on an upper part of the center console to retain a wide front view for the vehicle driver.

The housing 5 is formed from metal having high thermal conductivity or from a synthetic resin. As shown in FIG. 3, the housing 5 is a rectangular box. The housing 5 has a fin-like heat dissipation member 5f in its lower portion. As shown in FIG. 4, the housing 5 accommodates a main board 8. The plate surface of the main board 8 is substantially horizontal.

The main board 8 includes the control unit 1, the interface 4, connectors 15a and 15c, and other electronic components and electric circuits (not shown). The control unit 1 and the interface 4 may include semiconductor devices. The connector 15a is connected to one end of a flexible printed circuit (FPC) 17. The connector 15c is connected to one end of the harness 16 shown in FIGS. 2 and 3 (not shown in detail).

An opening 5k, which is open upward in the housing 5, receives the main board 8. As shown FIGS. 2 and 3, the opening 5k is closed by the lid 6. The lid 6 is fixed to the housing 5 by fasteners such as screws (not shown).

The lid 6 is formed from metal or a synthetic resin. As shown in FIG. 3, the lid 6 has a support 6h protruding upward from the middle and a through-hole 6k opening upward. The front surface of the support 6h (the surface facing lower right in FIG. 3) tilts with respect to the sides of the housing 5 or the lid 6.

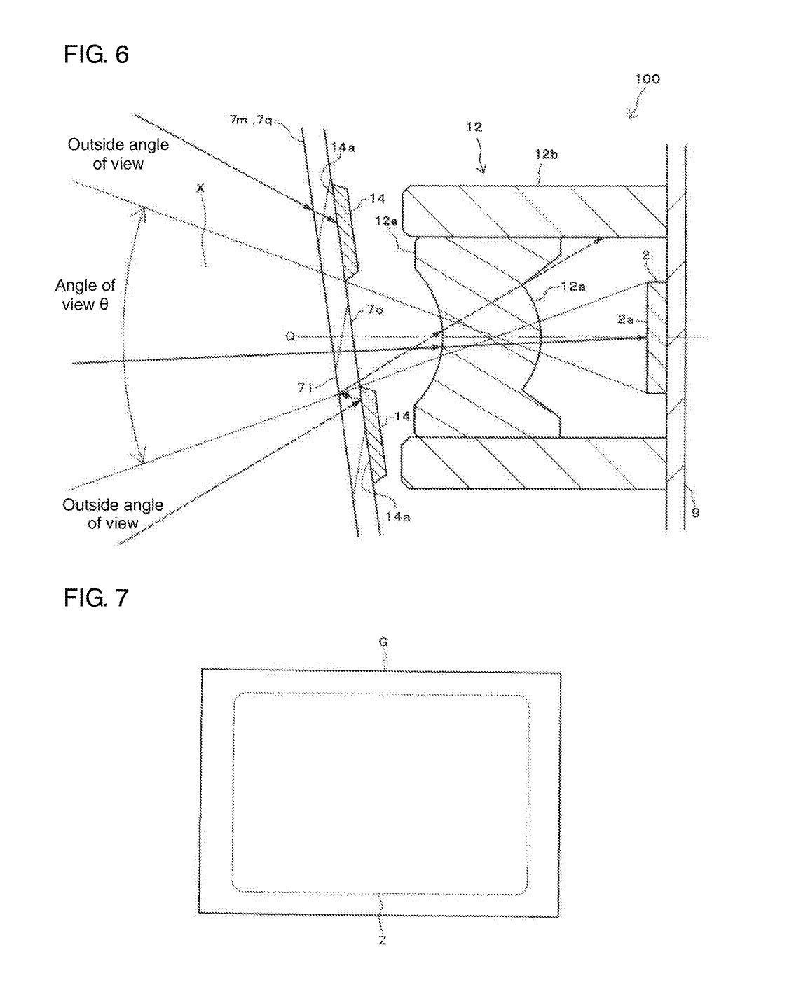

The support 6h supports a sub-board 9 on its front surface. The sub-board 9 has its plate surface extending vertical and is fixed to the support 6h with fasteners such as screws (not shown). The imaging device 2 (FIG. 6), the illuminator 3, the connector 15b, and other electronic components and electric circuits (not shown) are mounted on the surface of the sub-board 9 (the surface facing lower right in FIG. 3).

The connector 15b is connected to the other end of the FPC 17. The FPC 17 extends through the through-hole 6k in the lid 6. The FPC 17 electrically connects the sub-board 9 to the main board 8.

The sub-board 9 has a reflector 10 on its front surface for reflecting light. The reflector 10 is fixed to the sub-board 9 or the support 6h of the lid 6 with fasteners such as screws (not shown). The reflector 10 has a plurality of through-holes 10a to 10e. The through-holes 10b to 10e with a smaller diameter each accommodate an LED of the illuminator 3 at a deep position.

The through-hole 10a in the middle with a larger diameter receives a lens unit 12 in a fitting manner. The lens unit 12 includes a lens 12a and a holder 12b, which holds the lens 12a. The holder 12b is cylindrical. The holder 12b is formed from a light-shielding synthetic resin. As shown in FIG. 6, the holder 12b is fixed to the sub-board 9 to allow the lens 12a to face the imaging device 2 mounted on the front surface of the sub-board 9. The holder 12b is an example of a holder of the claimed invention.

The cover 7 shown in FIG. 2 is formed from a light-shielding synthetic resin. The cover 7 includes a horizontal portion 7h and a vertical portion 7u. The vertical portion 7u is at the rear of the horizontal portion 7h, and protrudes upward continuously from the horizontal portion 7h. As shown in FIG. 5, the vertical portion 7u includes a front side wall 7uf, lateral side walls 7uL and 7ur, and a ceiling wall 7uj. The back of the vertical portion 7u (opposite to the front side wall 7uf) is open rearward.

The front side wall 7uf in the vertical portion 7u has a substantially rectangular hole 7t in its upper portion. A transmissive plate 7q is attached to the cover 7 to close the hole 7t (refer to FIG. 2). The transmissive plate 7q is formed from a light transmissive synthetic resin. The hole 7t and the transmissive plate 7q form the window 7m, which allows entry and exit of light. More specifically, the front side wall 7uf of the cover 7 has the window 7m in its upper portion. As shown in FIG. 5, the transmissive plate 7q is a flat plate. The transmissive plate 7q has a baffle 14 on its back surface 7o.

As shown in FIG. 2, the lens unit 12 shown in FIG. 3 and other figures, the imaging device 2 (FIG. 6), the illuminator 3, the sub-board 9, and the FPC 17 are covered by the cover 7 from above and from the front (the side opposite to the harness 16). The cover 7 also covers the front portions of the lid 6 and the housing 5 from above and the front. The cover 7 is fixed to the support 6h on the lid 6 with screws (not shown). The cover 7 is an example of a cover of the claimed invention.

The transmissive plate 7q faces the lens 12a and the illuminator 3, with the cover 7 attached as shown in FIG. 2. The window 7m in the cover 7, or in other words the hole 7t and the transmissive plate 7q, has a larger diameter than the lens 12a. The window 7m has a larger diameter to serve both as an exit for light from the illuminator 3 and an entry for light into the lens 12a. The larger range of light emission and reception also increases the image capturing range to enable capturing of an image of the entire face of the driver.

A portion under the horizontal portion 7h of the cover 7 in FIG. 2 is embedded in the dash board or the center console to be unseen by an occupant of the vehicle. A portion above the horizontal portion 7h of the cover 7 includes an illuminating system including the reflector 10, the illuminator 3, and the window 7m and the imaging system including the lens unit 12, the imaging device 2, and the window 7m. To capture an image of the face of the driver, the illuminating system and the imaging system protrude from the dash board or the center console. Also, the illuminating system and the imaging system are covered with a design cover (not shown) so that the driver is unaware of being monitored. The design cover has an opening to expose the transmissive plate 7q.

The occupant monitoring apparatus 100 is mounted in the middle of the dash board or on the upper part of the center console to allow the illuminator 3, the lens 12a, and the imaging device 2 to face the driver seat. Thus, light emitted from the illuminator 3 passes through the through-holes 10b to 10e in the reflector 10, the window 7m in the cover 7, and the opening in the design cover, and is then projected onto the driver seat.

The projected light is then reflected by, for example, the headrest and the seat of the driver seat, or the face of the driver seated in the driver seat. The reflected light passes through the opening in the design cover and the window 7m in the cover 7, enters the lens 12a in the lens unit 12 fitted in the through-hole 10a in the reflector 10, and then enters the imaging device 2. The imaging device 2 converts the light received from the lens 12a into an electric signal, and captures an image of the face of the driver and other objects based on the electric signal.

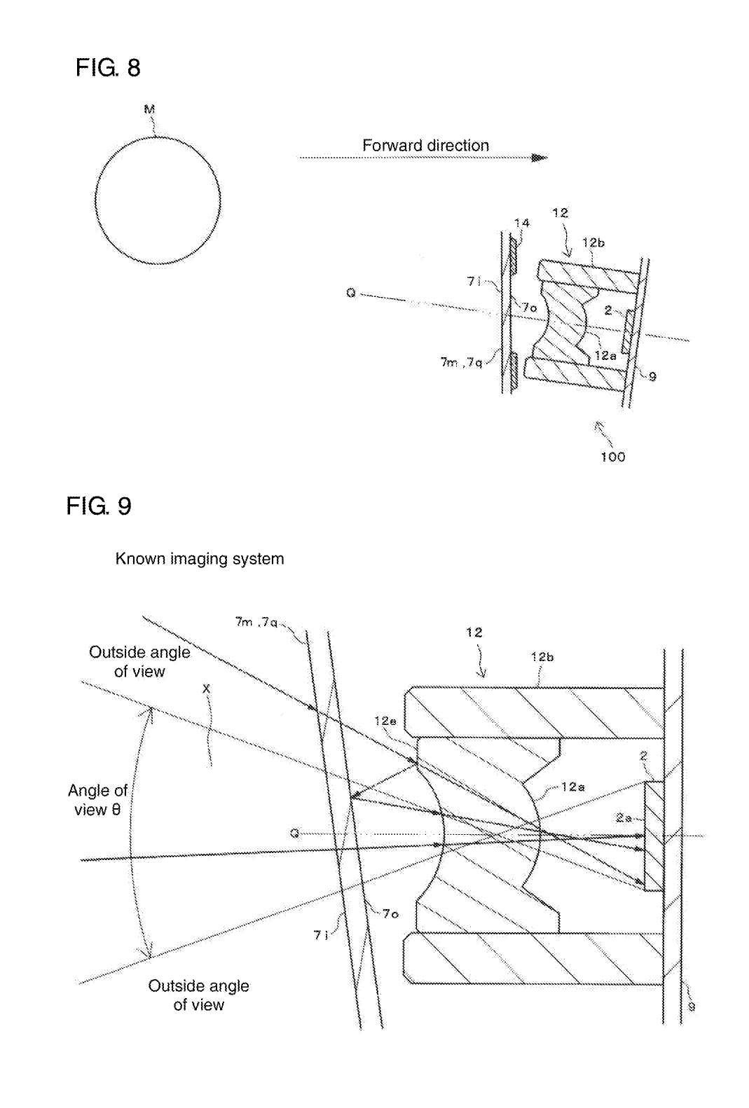

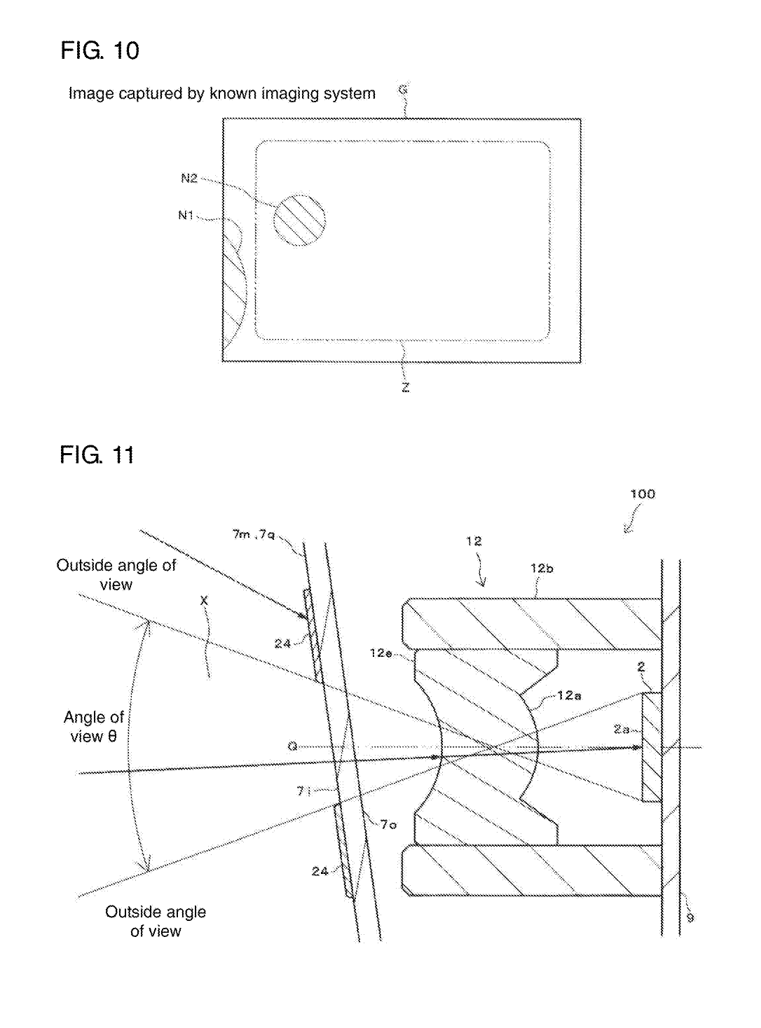

FIG. 6 is a cross-sectional view of the imaging system included in the occupant monitoring apparatus 100. FIG. 7 is a diagram describing an example of an image G captured by the imaging system shown in FIG. 6. FIG. 8 is a diagram describing the posture of the imaging system shown in FIG. 6 as installed. FIG. 9 is a cross-sectional view of an imaging system included in a known occupant monitoring apparatus. FIG. 10 is a diagram describing an example of an image G′ captured by the imaging system shown in FIG. 9. FIGS. 6, 8, and 9 each show a horizontal cross section, in which the reflector 10 is not shown. (The same applies to FIGS. 11 to 15 described later.)

In FIG. 6, the holder 12b in the lens unit 12 included in the occupant monitoring apparatus 100 accommodates the lens 12a and the imaging device 2.

The holder 12b surrounds and holds the lens 12a. The imaging device 2 is mounted on the sub-board 9. The imaging surface 2a of the imaging device 2 and the lens 12a face each other at a predetermined distance. The lens 12a has an optical axis Q, which is perpendicular to the imaging surface 2a of the imaging device 2. The imaging surface 2a has its center aligned with the optical axis Q of the lens 12a. The lens 12a focuses light reflected from the driver (or forms a driver image) onto the imaging surface 2a of the imaging device 2.

The transmissive plate 7q, which forms the window 7m in the cover 7, is arranged opposite to the imaging device 2 at a predetermined distance from the lens 12a. The transmissive plate 7q has both plate surfaces 7i and 7o tilting at a predetermined angle with respect to the optical axis Q of the lens 12a. Among the plate surfaces 7i and 7o of the transmissive plate 7q, the plate surface 7o facing the imaging device 2 includes the baffle 14.

The baffle 14 is a single annular component (refer to FIG. 5) that surrounds a range X of an angle of view θ of the lens 12a. FIG. 6 is a radial cross section for the baffle 14, showing two cross sectional parts. (The same applies to the baffles 24, 34, 44, and 14 shown in FIGS. 11 to 14 described later.)

The baffle 14, which is a flat plate, extends radially outward from positions near the range X of the angle of view θ of the lens 12a. The baffle 14 has a larger outer diameter than the lens 12a. The baffle 14 is sized to unblock light from the illuminator 3 (FIG. 3). The baffle 14 has a plate surface 14a in close contact with the plate surface 7o of the transmissive plate 7q. The plate surface 14a of the baffle 14 and the plate surfaces 7i and 7o of the transmissive plate 7q are parallel to each other. The baffle 14 blocks light from outside the angle of view θ and prevents the light from entering the lens 12a. The baffle 14 is an example of a light shield of the claimed invention.

As described above, the occupant monitoring apparatus 100 is mounted diagonally in front of the driver seat in the vehicle interior. Thus, the lens 12a and the imaging surface 2a of the imaging device 2 face a driver M in the driver seat as shown in FIG. 8. The optical axis Q of the lens 12a tilts at a predetermined angle with respect to the forward direction of the vehicle. The plate surfaces 7i and 7o of the transmissive plate 7q are perpendicular to the forward direction of the vehicle.

An imaging system included in a known occupant monitoring apparatus shown in FIG. 9 includes no baffle 14. Except the baffle 14, the imaging system is the same as the imaging system included in the occupant monitoring apparatus 100 shown in FIG. 6.

As described above, light from the illuminator 3 is reflected by, for example, the face of the driver M. As indicated by solid arrows in FIGS. 6 and 9, the reflected light, or the light reflected from the driver M (the image of the driver M), travels within the angle of view θ of the lens 12a. The light passes through the transmissive plate 7q, and then enters the imaging surface 2a of the imaging device 2 through the lens 12a. Thus, the imaging device 2 captures the face image of the driver M. The face image of the driver M appears (not shown) in the central area Z of the images G and G′ shown in FIGS. 7 and 10. As the driver M behaves variously, the face image of the driver M appears at different positions within the central area Z.

The transmissive plate 7q with a larger diameter than the lens 12a receives ambient light from outside the angle of view θ. Such ambient light, including sunlight, has higher luminance than the light reflected from the driver M.

As indicated by dot-and-dash arrows in FIG. 9, ambient light entering the transmissive plate 7q in a known apparatus from outside the angle of view θ of the lens 12a passes through the transmissive plate 7q, enters the lens 12a through an end face (front surface) 12e, and then reaches a peripheral portion of the imaging surface 2a or a position near the imaging surface 2a of the imaging device 2. As shown in FIG. 10, noise N1 caused by the ambient light appears at a peripheral portion of the image G′. No noise N1 appears in the central area Z overlapping the face image of the driver M. However, the noise N1, which has higher luminance than the face image of the driver M, may disable detection of the face of the driver M when the face image of the driver M appears near the noise N1.

As indicated by two-dot chain arrows in FIG. 9, ambient light passing through the transmissive plate 7q from outside the angle of view θ of the lens 12a is partially reflected by the end face 12e of the lens 12a. The reflected light becomes stray light between the lens 12a and the transmissive plate 7q. The stray light travels within the angle of view θ of the lens 12a, and is reflected by the plate surface 7o of the transmissive plate 7q. The light then enters the lens 12a at a position near the optical axis Q of the lens 12a. The plate surfaces 7i and 7o of the transmissive plate 7q tilt with respect to the optical axis Q of the lens 12a. The end face 12e of the lens 12a and the plate surface 7o are not parallel to each other. The stray light thus enters the lens 12a at an angle (indicated by the two-dot chain arrows in FIG. 9) different from the incident angle of the ambient light with respect to the lens 12a (angle indicated by the dot-and-dash arrows in FIG. 9). The stray light then passes through the lens 12a within the angle of view θ of the lens 12a, and enters the imaging surface 2a of the imaging device 2. As shown in FIG. 10, noise N2 caused by the stray light, which is generated between the lens 12a and the transmissive plate 7q, appears in the image G′. The noise N2 also has higher luminance than the face image of the driver M. The noise N2 appears in the central area Z overlapping the face image of the driver M, disabling detection of the face of the driver M.

As indicated by dot-and-dash arrows in FIG. 6, the ambient light passing through the transmissive plate 7q from outside the angle of view θ of the lens 12a is blocked by the baffle 14 and cannot enter the lens 12a in the imaging system in the occupant monitoring apparatus 100 shown in FIG. 6. This eliminates stray light between the transmissive plate 7q and the lens 12a resulting from ambient light entering from outside the angle of view θ of the lens 12a. The imaging surface 2a of the imaging device 2 thus receives no ambient light or stray light through the lens 12a. As shown in FIG. 7, this prevents the noise N1 caused by ambient light and the noise N2 caused by stray light shown in FIG. 10 from appearing in the image G.

As indicated by dashed arrows in FIG. 6, the ambient light passing through the transmissive plate 7q from outside the angle of view θ of the lens 12a may be reflected by the plate surface 14a of the baffle 14 and the plate surfaces 7i of the transmissive plate 7q. The reflected light may become stray light inside the transmissive plate 7q, and may enter the lens 12a. However, the plate surface 14a of the baffle 14 and the plate surfaces 7i of the transmissive plate 7q are parallel to each other, and thus the stray light enters the lens 12a at the same incident angle as the ambient light with respect to the transmissive plate 7q. When passing through the lens 12a, the stray light falls on the inner circumference surface of the holder 12b, and cannot enter the imaging surface 2a of the imaging device 2. This prevents noise caused by the stray light generated inside the transmissive plate 7q from appearing in the image G shown in FIG. 7.

In the above embodiment, the baffle 14 blocks ambient light, such as sunlight, passing through the transmissive plate 7q from outside the angle of view θ of the lens 12a, and prevents the light from entering the lens 12a, although the transmissive plate 7q has a larger diameter than the lens 12a and the transmissive plate 7q tilts with respect to the optical axis Q of the lens 12a. This structure prevents ambient light entering from outside the angle of view θ of the lens 12a from entering the imaging surface 2a of the imaging device 2 through the lens 12a. This structure also prevents ambient light entering from outside the angle of view θ of the lens 12a from being reflected by the end face 12e of the lens 12a and becoming stray light, and further prevents such stray light from passing through the lens 12a and entering the imaging surface 2a of the imaging device 2. This prevents noise N1 caused by ambient light entering from outside the angle of view θ and noise N2 caused by stray light (FIG. 10) from appearing in the image G captured by the imaging device 2 (FIG. 7), thus allowing accurate detection of the face or the face feature points of the driver M based on the image G, and improving the monitoring performance of the driver M.

When the baffle 14 is located on the plate surface 7o facing the imaging device 2, ambient light passing through the transmissive plate 7q from outside the angle of view θ of the lens 12a may be reflected by the baffle 14 or by the other plate surface 7i. The reflected light may become stray light inside the transmissive plate 7q. In the present embodiment, the plate surfaces 7i and 7o of the transmissive plate 7q and the plate surface 14a of the baffle 14 are parallel to each other. This structure prevents such stray light inside the transmissive plate 7q from entering the imaging surface 2a of the imaging device 2 through the lens 12a. This prevents noise caused by stray light from appearing in the image G. The baffle 14 and the transmissive plate 7q may be integrated together to reduce the number of components. In this case, the baffle 14 can be easily located opposite to the imaging device 2 from the lens 12a. This facilitates the assembly of the occupant monitoring apparatus 100.

In the above embodiment, the baffle 14 is annular to surround the range X of the angle of view θ of the lens 12a. Thus, the baffle 14 reliably blocks ambient light entering from outside the angle of view θ in any directions and prevents the ambient light from entering the lens 12a.

In the above embodiment, the baffle 14 extends radially outward from positions near the range X of the angle of view θ of the lens 12a, and has a larger outer diameter than the lens 12a. The baffle 14 thus reliably blocks ambient light entering the transmissive plate 7q from outside the angle of view θ outside the diameter of the lens 12a and prevents the ambient light from entering the lens 12a.

In the above embodiment, the transmissive plate 7q has a larger diameter than the lens 12a. This increases the image capturing range. The occupant monitoring apparatus 100 is mounted in the middle of the vehicle interior to capture the driver M within the angle of view θ of the lens 12a. When the occupant monitoring apparatus 100 is at a short distance from the driver M, light reflected from the driver M enters the imaging surface 2a of the imaging device 2 through the transmissive plate 7q and the lens 12a. The imaging device 2 reliably captures an image of the face of the driver M.

FIG. 11 is a cross-sectional view of an imaging system included in an occupant monitoring apparatus 100 according to a second embodiment of the present invention. In the second embodiment, a baffle 24, which is a light shield, is located on the plate surface 7i of the transmissive plate 7q opposite to the imaging device 2. The baffle 24 is annular to surround the range X of the angle of view θ of the lens 12a. The baffle 24, which extends radially outward from positions near the range X of the angle of view θ of the lens 12a, is sized to unblock light from the illuminator 3. The other structure is the same as described in the first embodiment.

As indicated by a dot-and-dash arrow in FIG. 11, the baffle 24 blocks ambient light entering from outside the angle of view θ of the lens 12a and prevents the ambient light from entering the transmissive plate 7q. No stray light is generated from ambient light from outside the angle of view θ inside the transmissive plate 7q or between the transmissive plate 7q and the lens 12a. Thus, no stray light and ambient light enters the imaging surface 2a of the imaging device 2 through the lens 12a. This prevents noise N1 or N2 (FIG. 10) that may disable detection of the face or other feature of the driver M from appearing in the image G.

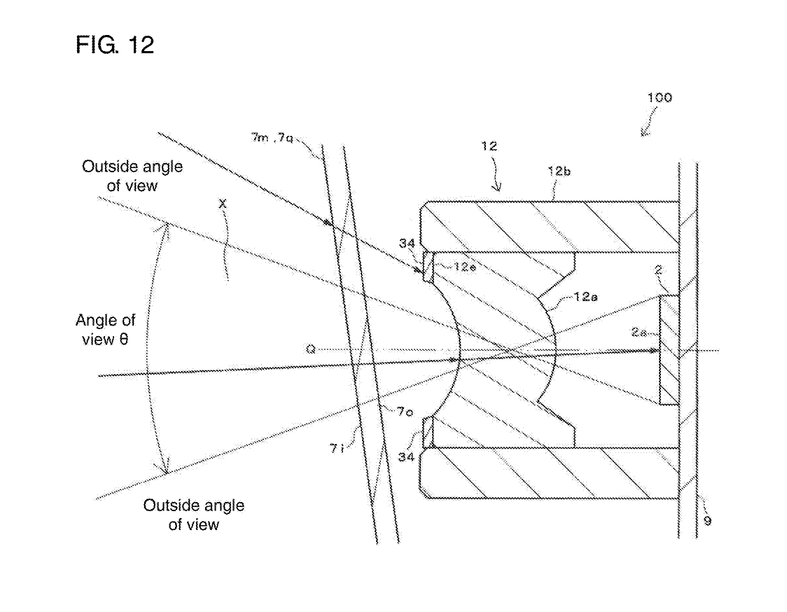

FIG. 12 is a cross-sectional view of an imaging system included in an occupant monitoring apparatus 100 according to a third embodiment of the present invention. In the third embodiment, a baffle 34, which is a light shield, is located on the end face 12e of the lens 12a. The baffle 34 is annular to surround the range X of the angle of view θ of the lens 12a. The baffle 34 extends radially outward from positions near the range X of the angle of view θ of the lens 12a. The baffle 34 has a surface receiving anti-light reflection treatment. The other structure is the same as described in the first embodiment.

As indicated by dot-and-dash arrows in FIG. 12, the baffle 34 blocks ambient light entering from outside the angle of view θ of the lens 12a and passing through the transmissive plate 7q from entering the lens 12a. The ambient light does not reflect on the surface of the baffle 34. This eliminates stray light between the transmissive plate 7q and the lens 12a resulting from the ambient light entering from outside the angle of view 8. The imaging surface 2a of the imaging device 2 thus receives no ambient light or no stray light through the lens 12a. This prevents noise N1 or N2 (FIG. 10) that may disable detection of the face or other feature of the driver M from appearing in the image G.

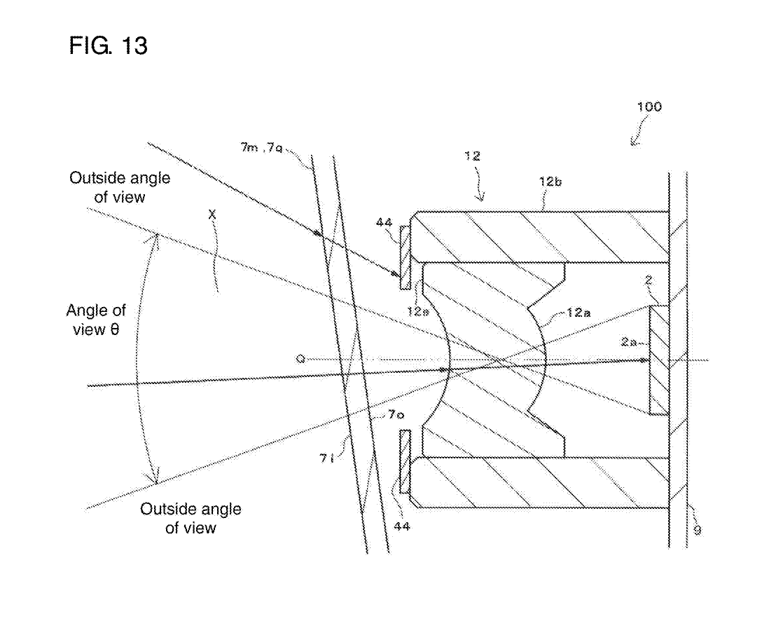

FIG. 13 is a cross-sectional view of an imaging system included in an occupant monitoring apparatus 100 according to a fourth embodiment of the present invention. In the fourth embodiment, a baffle 44, which is a light shield, is located between the transmissive plate 7q and the lens 12a. The baffle 44 is fixed to the holder 12b to be separated from the transmissive plate 7q and the lens 12a. The baffle 44 is annular to surround the range X of angle of view θ of the lens 12a. The baffle 44 extends radially outward from positions near the range X of the angle of view 8 of the lens 12a. The baffle 44 is sized to unblock light from the illuminator 3. The baffle 44 has a surface receiving anti-light reflection treatment. The other structure is the same as described in the first embodiment.

As indicated by dot-and-dash arrows in FIG. 13, the baffle 44 blocks ambient light entering from outside the angle of view θ of the lens 12a and passing through the transmissive plate 7q, and prevents the ambient light from entering the lens 12a. The ambient light does not reflect on the surface of the baffle 44. This eliminates stray light between the transmissive plate 7q and the lens 12a resulting from the ambient light entering from outside the angle of view θ. The imaging surface 2a of the imaging device 2 thus receives no ambient light or stray light through the lens 12a. This prevents noise N1 or N2 (FIG. 10) that may disable detection of the face or other feature of the driver M from appearing in the image G.

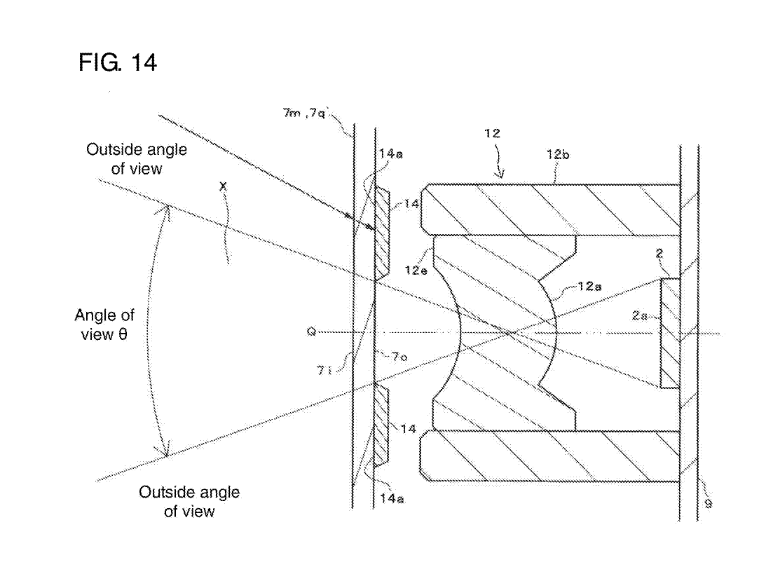

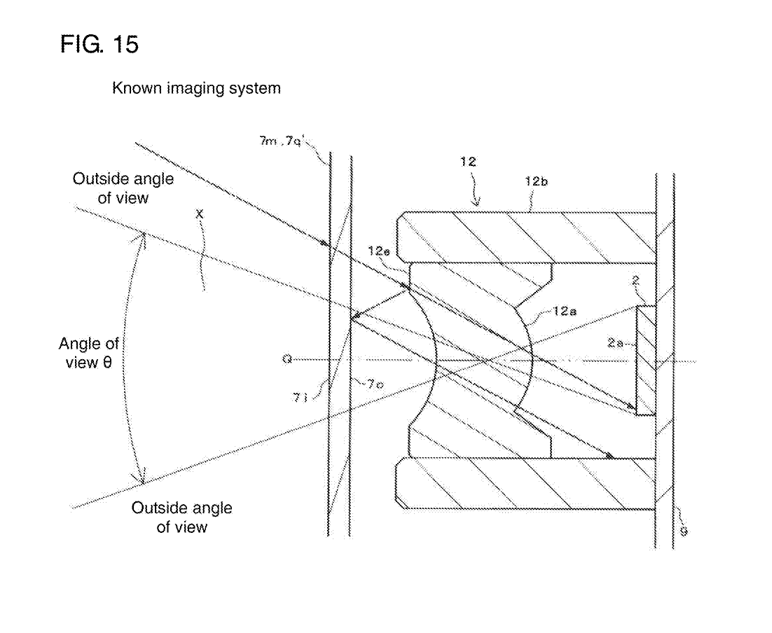

FIG. 14 is a cross-sectional view of an imaging system included in an occupant monitoring apparatus 100 according to a fifth embodiment of the present invention. FIG. 15 is a cross-sectional view of an imaging system included in a known occupant monitoring apparatus with a structure corresponding to the system shown in FIG. 14.

In the imaging system according to the fifth embodiment shown in FIG. 14, plate surfaces 7i and 7o of a transmissive plate 7q′, which is located in the window 7m in the cover 7, are perpendicular to the optical axis Q of the lens 12a. The plate surfaces 7i and 7o of the transmissive plate 7q′ and the end face 12e of the lens 12a are parallel to each other. The baffle 14 is located on the plate surface 7o of the transmissive plate 7q′. The baffle 14 is attached to the transmissive plate 7q′ in the same manner as on the transmissive plate 7q in the first embodiment (FIG. 6). The other structure is also the same as described in the first embodiment.

In contrast, the known imaging system shown in FIG. 15 has no baffle 14. As indicated by dot-and-dash arrows in FIG. 15, ambient light entering from outside the angle of view θ of the lens 12a passes through the transmissive plate 7q′, enters the end face 12e of the lens 12a, and then reaches a peripheral portion of the imaging surface 2a or a position near the imaging surface 2a of the imaging device 2. Noise caused by the ambient light, such as noise N1 shown in FIG. 10, thus appears at a peripheral portion of the image G.

As indicated by two-dot chain arrows in FIG. 15, ambient light entering from outside the angle of view θ of the lens 12a and passing through the transmissive plate 7q′ is partially reflected by the end face 12e of the lens 12a. The reflected light becomes stray light between the lens 12a and the transmissive plate 7q′. Such stray light travels within the angle of view θ of the lens 12a, and is reflected by the plate surface 7o of the transmissive plate 7q′, and then enters the lens 12a. The end face 12e of the lens 12a and the plate surface 7o of the transmissive plate 7q′ are parallel to each other. The stray light thus enters the lens 12a at the same incident angle as the ambient light with respect to the lens 12a. Thus, such stray light passing through the lens 12a falls on the inner peripheral surface of the holder 12b, and cannot enter the imaging surface 2a of the imaging device 2. This prevents noise caused by the stray light generated between the lens 12a and the transmissive plate 7q′ from appearing in the image G.

As indicated by a dot-and-dash arrow in FIG. 14, the ambient light passing through the transmissive plate 7q′ from outside the angle of view θ of the lens 12a is blocked by the baffle 14 on the transmissive plate 7q′ and cannot enter the lens 12a. This eliminates stray light between the transmissive plate 7q′ and the lens 12a resulting from the ambient light. The imaging surface 2a of the imaging device 2 thus receives no ambient light or stray light through the lens 12a. This prevents noise caused by the ambient light, such as noise N1 shown in FIG. 10, from appearing at a peripheral portion of the image G captured by the imaging device 2. This prevents noise that may disable detection of the face or other feature of the driver M from appearing in the image G.

The present invention may be implemented in many embodiments other than the above embodiments. In the above embodiments, the baffles 14, 24, 34, and 44 are located outside the angle of view θ of the lens 12a. In some embodiments, the baffles 14, 24, 34, and 44 may partially protrude within the angle of view θ of the lens 12a. In the same manner as the baffles 34 and 44, the baffles 14 and 24 may also have their surfaces receiving anti-light reflection treatment. The baffles 14, 24, 34, or 44 may be replaced by a thicker block light shield, or may be replaced by a plurality of light shields located opposite to the imaging device 2 from the lens 12a.

In the above embodiments, the hole 7t and the transmissive plate 7q or 7q′ form the window 7m in the cover 7. In some embodiments, the transmissive plates 7q and 7q′ may be eliminated, and the hole 7t alone may form the window 7m. The window 7m, the hole 7t, and the transmissive plate 7q or 7q′ may have the same diameter as the lens 12a or may have a smaller diameter than the lens 12a. The transmissive plates 7q and 7q′ located at the window 7m may have the same diameter as the lens 12a or may have a smaller diameter than the lens 12a. A window as an exit for light from the illuminator 3 and a window as an entry for light into the lens 12a may be provided separately.

In the above embodiments, the transmissive plates 7q and 7q′ are located at the window 7m in the cover 7, which is covered with a design cover. In some embodiments, the hole 7t alone may form the window 7m, and a transmissive plate may be at an opening in the design cover, which communicates with the hole 7t. A light shield may be on the transmissive plate or between the design cover and the cover 7.

In the above embodiments, the imaging device 2 includes an infrared image sensor, and the illuminator 3 includes infrared light emitting diodes (LEDs). In some embodiments, another imaging device or another illuminator may be used. Any number of imaging devices and illuminators may be installed.

In the above embodiments, the occupant monitoring apparatus 100 is mounted in the middle of the dash board or on an upper part of the center console. In some embodiments, the occupant monitoring apparatus 100 may be mounted at another position in the vehicle interior.

In the above embodiments, the occupant monitoring apparatus 100 monitors the driver M by capturing an image of the face of the vehicle driver M. The embodiments according to the present invention may be applicable to an occupant monitoring apparatus for monitoring an occupant other than the driver M or capturing an image of a part other than a face.

In the above embodiments, the occupant monitoring apparatus 100 is installed in an automobile. The embodiments according to the present invention may be applicable to an occupant monitoring apparatus installed in another vehicle.

1. An occupant monitoring apparatus for monitoring an occupant based on an image captured by an imaging device, the apparatus comprising:
an imaging device configured to capture an image of an occupant of a vehicle;
a lens configured to form the image of the occupant onto an imaging surface of the imaging device;
a holder holding the lens;
a cover covering the imaging device, the lens, and the holder;
a window located in the cover to allow light to enter the lens; and
a light shield located opposite to the imaging device from the lens, the light shield being configured to block light entering from outside an angle of view of the lens and prevent the light from entering the lens.

2. The occupant monitoring apparatus according to claim 1, wherein
the window includes
a hole in the cover, and
a transmissive plate attached to the cover to close the hole, and configured to transmit light, and
the transmissive plate has plate surfaces tilting with respect to an optical axis of the lens.

3. The occupant monitoring apparatus according to claim 2, wherein
the transmissive plate has a larger diameter than the lens.

4. The occupant monitoring apparatus according to claim 2, wherein
the light shield is a plate, and is located on a plate surface of the transmissive plate facing the imaging device, and
a plate surface of the light shield and the plate surfaces of the transmissive plate are parallel to each other.

5. The occupant monitoring apparatus according to claim 1, wherein
the light shield is annular to surround a range of the angle of view of the lens.

6. The occupant monitoring apparatus according to claim 5, wherein
the light shield extends radially outward from positions adjacent to the range of the angle of view of the lens, and
the light shield has a larger outer diameter than the lens.

7. The occupant monitoring apparatus according to claim 1, wherein
the light shield has a surface receiving anti-light reflection treatment.
